(19) United States
(12) Patent Application Publication
(10) Pub. No.: US 2017/0075019 A1
(43) Pub. Date: Mar. 16, 2017

(54) METHOD AND SYSTEM FOR DRIVING A CAPACITIVE SENSOR

(71) Applicant: Magna Closures Inc., Newmarket (CA)

(72) Inventors: Mirko Pribisic, North York (CA); Allan Corner, Aurora (CA); Xiaoping Hu, Markham (CA); Mike Akbari, Richmond Hill (CA); Timothy Dezorzi, South Lyon, MI (US)

(21) Appl. No.: 15/121,982

(22) PCT Filed: Mar. 12, 2015
(86) PCT No.: PCT/CA2015/000157

§ 371 Date: Aug. 26, 2016

Related U.S. Application Data
(60) Provisional application No. 61/954,005, filed on Mar. 17, 2014.

(51) Int. Cl. G01V 3/08; E05F 15/73; E05F 15/46

(52) U.S. Cl. CPC G01V 3/088; E05F 15/46; E05F 15/73; E05Y 2900/546

(57) ABSTRACT

A method for determining a capacitance value of a capacitive sensor begins by applying a sensor signal (Vx) to the capacitive sensor. The sensor signal (Vx) includes a number of charge-discharge pulse pairs distributed over a first period of time (T/N), with each pulse pair having a different pulse period. The method then proceeds by accumulating a number (N) of samples of a reference voltage (Vs) measured across a reference capacitor (Cs) that is coupled to the capacitive sensor over a second period of time (T) to produce an accumulated capacitance value (ACCUMULATED). The accumulated capacitance value (ACCUMULATED) is then divided by the number (N) of the samples to determine the capacitance value (Cx) of the capacitive sensor.

### CROSS-REFERENCE TO RELATED APPLICATIONS

This application claims the benefit of U.S. Provisional Application No. 61/954,005 filed Mar. 17, 2014. The entire disclosure of the above application is incorporated herein by reference.

### FIELD OF THE INVENTION

This invention generally relates to the field of capacitive sensors, and more specifically, to a method and system for driving a capacitive sensor for use in vehicles and other devices.

### BACKGROUND

This section provides background information related to the present disclosure which is not necessarily prior art.

In motor vehicles such as minivans, sport utility vehicles and the like, it has become common practice to provide the vehicle body with a large rear opening. A liftgate (also referred to as a tailgate) is typically mounted to the vehicle body or chassis with hinges for pivotal movement about a transversely extending axis between an open position and a closed position. Typically, the liftgate may be operated manually or with a power drive mechanism including a reversible electric motor.

During operation of a power liftgate system in a motor vehicle, the liftgate may unexpectedly encounter an object or obstacle in its path. It is therefore desirable to cease its powered movement in that event to prevent damage to the obstacle and/or to the liftgate by impact or by pinching of the obstacle between the liftgate and vehicle body.

Obstacle sensors are used in such vehicles equipped with a power liftgate system to prevent the liftgate from closing if an obstacle (e.g., a person, etc.) is detected as the liftgate closes. Obstacle sensors come in different forms, including non-contact or proximity sensors which are typically based on capacitance changes. These non-contact/proximity sensors are commonly referred to as capacitive sensors.

Capacitive sensors typically include a metal strip or wire which is embedded in a plastic or rubber strip which is routed along and adjacent to the periphery of the liftgate. The metal strip or wire and the chassis of the vehicle collectively form the two plates or electrodes of a sensing capacitor. An obstacle placed between these two electrodes changes the dielectric constant and thus varies the amount of charge stored by the sensing capacitor over a given period of time. The charge stored by the sensing capacitor is transferred to a reference capacitor in order to detect the presence of the obstacle. The capacitive sensor is typically driven by a pulsed signal from a controller which, in turn, also typically controls operation of the power drive mechanism associated with the power liftgate system.

One problem with such capacitive sensors relates to their sensing range. Longer range sensing would be useful in several applications.

A need therefore exists for an improved method an system for driving a capacitive sensor for use in vehicles and other devices. Accordingly, a solution that addresses, at least in part, the above and other shortcomings is desired.

### SUMMARY OF THE INVENTION

This section provides a summary of the disclosure and is not intended to be a comprehensive disclosure of its full scope or all of its aspects, objectives and/or features.

According to one aspect of the present disclosure, there is provided a method for determining a capacitance value of a capacitive sensor, comprising: applying a sensor signal to the capacitive sensor, the sensor signal including a number of charge-discharge pulse pairs distributed over a first period of time, each pulse pair having a different pulse period; accumulating a number of samples of a reference voltage measured across a reference capacitor coupled to the capacitive sensor over a second period of time to produce an accumulated capacitance value; and dividing the accumulated capacitance value by the number of the samples to determine the capacitance value.

In accordance with a related aspect of the present disclosure, the method for determining the capacitive value of a capacitive sensor is integrated into a capacitive sensing system for use in motor vehicles.

In accordance with another related aspect of the present disclosure, the capacitive sensing system is associated with a power liftgate system in a motor vehicle.

In accordance with yet another related aspect of the present disclosure, the capacitive sensing system can be associated with other powered system of a motor vehicle including power sliding doors, power windows and power sunroofs.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Features and advantages of the embodiments of the present invention will become apparent from the following detailed description, taken in combination with the appended drawings, in which:

FIG. 1 is rear perspective view illustrating a capacitive sensing system for a power liftgate system of a motor vehicle that is constructed and operable in accordance with the teachings of the present disclosure;

FIG. 2 is a block diagram illustrating the capacitive sensing system of FIG. 1 in accordance with an embodiment of the present disclosure;

FIG. 3 is a sectional view of a capacitive sensor adapted for use with the capacitive sensing system of FIGS. 1 and 2 and constructed in accordance with an embodiment of the present disclosure;

FIG. 4 is a block diagram illustrating a sensing circuit for the capacitive sensing system in accordance with an embodiment of the present disclosure;

FIG. 5 is a flow chart illustrating operations of modules within the capacitive sensing system for determining a capacitive value of a capacitive sensor in accordance with the present disclosure; and

FIG. 6 is a table listing exemplary duty cycles for a sensor signal in accordance with an embodiment of the present disclosure.

It will be noted that throughout the appended drawings, like features are identified by like reference numerals.

### DETAILED DESCRIPTION OF THE EXEMPLARY EMBODIMENTS

In the following description, details are set forth to provide an understanding of the invention. In some instances, certain circuits, structures and techniques have not been described or shown in detail in order not to obscure the invention.

Example embodiments will now be described more fully with reference to the accompanying drawings. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

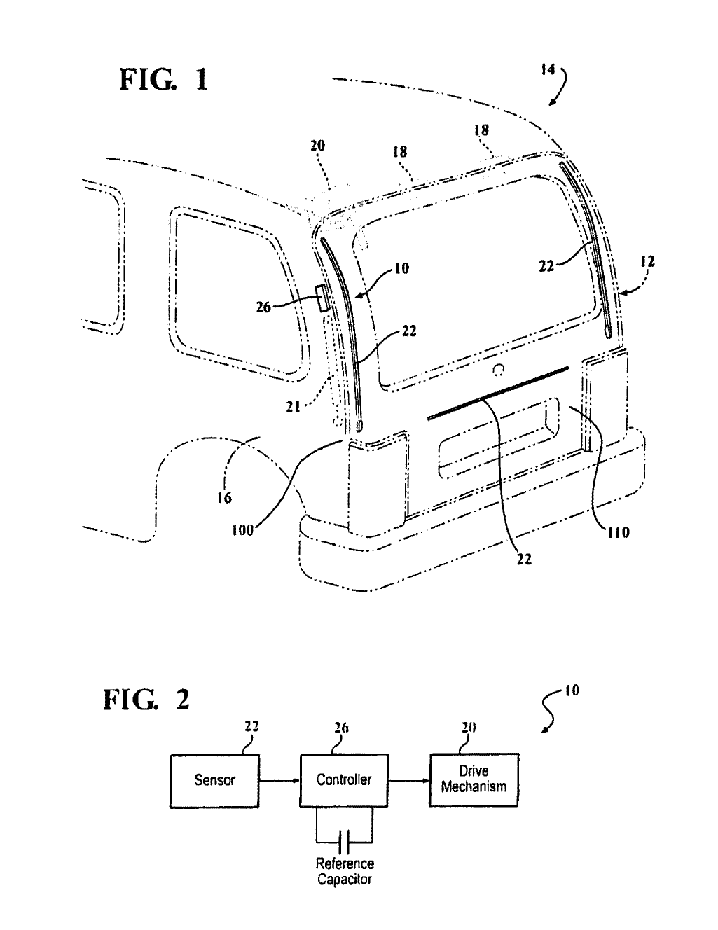

FIG. 1 is rear perspective view illustrating a capacitive sensing system 10 for a liftgate 12 of a motor vehicle 14 constructed and operable in accordance with an embodiment of the present disclosure. Capacitive sensing system 10 and liftgate 12 are part of a power liftgate system associated with motor vehicle 14. FIG. 2 is a block diagram illustrating capacitive sensing system 10 of FIG. 1 in accordance with the present disclosure.

Capacitive sensing system 10 is shown operatively associated with a closure panel, identified previously as liftgate 12, of motor vehicle 14. According to one embodiment, the closure panel is liftgate 12. It will be understood by those skilled in the art, however, that capacitive sensing system 10 may be used with other closure panels and/or windows of vehicles or in association with other device.

Liftgate 12 is mounted to a body 16 of vehicle 14 through a pair of hinges 18 to pivot about a transversely extending pivot axis with respect to a large opening 100 provided in the rear portion of body 16. Liftgate 12 is mounted to articulate about its hinge axis between a closed position where it closes opening 100 and an open position where it uncovers opening 100 for free access to the vehicle body interior and assumes a slightly upwardly angled position above horizontal. Liftgate 12 is secured in its closed position by a latching mechanism (not shown). Liftgate 12 is opened and closed by a power-operated drive mechanism 20 with the optional assist of a pair of gas springs 21 connected between liftgate 12 and body 16. Drive mechanism 20 may be similar to that described in PCT International Patent Application No. PCT/CA2012/000870, filed Sep. 20, 2012, and which is incorporated herein by reference. Drive mechanism 20 may be or include a powered strut as described in U.S. Pat. No. 7,938,473, issued May 20, 2011, and which is also incorporated herein by reference.

According to one embodiment, capacitive sensing system 10 includes one or more sensors 22 and a controller 26. A plurality of three (3) sensors 22 are illustrated in FIG. 1 associated with liftgate 12. Sensors 22 may be positioned to cover an area 110 located on the inner side of liftgate 12. Sensors 22 may be electrically coupled to an optional wire harness (not shown) adapted to plug into controller 26. Controller 26 normally controls drive mechanism 20 for opening and closing liftgate 12. However, controller 26 also controls drive mechanism 20 to automatically open liftgate 12 in the event it receives an appropriate electrical signal from one or more of sensors 22.

In operation, when liftgate 12 approaches an obstacle proximate to one or more of sensors 22 as it is articulated towards its closed position, the one or more sensors 22 are activated. The activation of one or more sensors 22 is detected by controller 26. In response, controller 26 reverses drive mechanism 20 to articulate liftgate 12 to its open position.

Drive mechanism 20 is controlled in part by capacitive sensing system 10. Capacitive sensing system 10 includes, as noted, elongate sensors 22 that help prevent liftgate 12 from contacting or impacting an obstacle such a person's hand or head (not shown) that maybe extending through opening 100 when liftgate 12 lowers towards its closed position. It will be appreciated by those skilled in the art that capacitive sensing system 10 may be applied to any motorized or automated closure panel structure that moves between an open position and a closed position. For example, a non-exhaustive list of closure panels includes window panes, sliding doors, tailgates, sunroofs and the like. For applications such as window panes or sun roofs, the elongate sensors 22 may be mounted on the body 16 of the vehicle 14, and for applications such as powered liftgates and sliding doors the elongate sensors 22 may be mounted on the closure panel itself, e.g., within the trim panel of the liftgate 12.

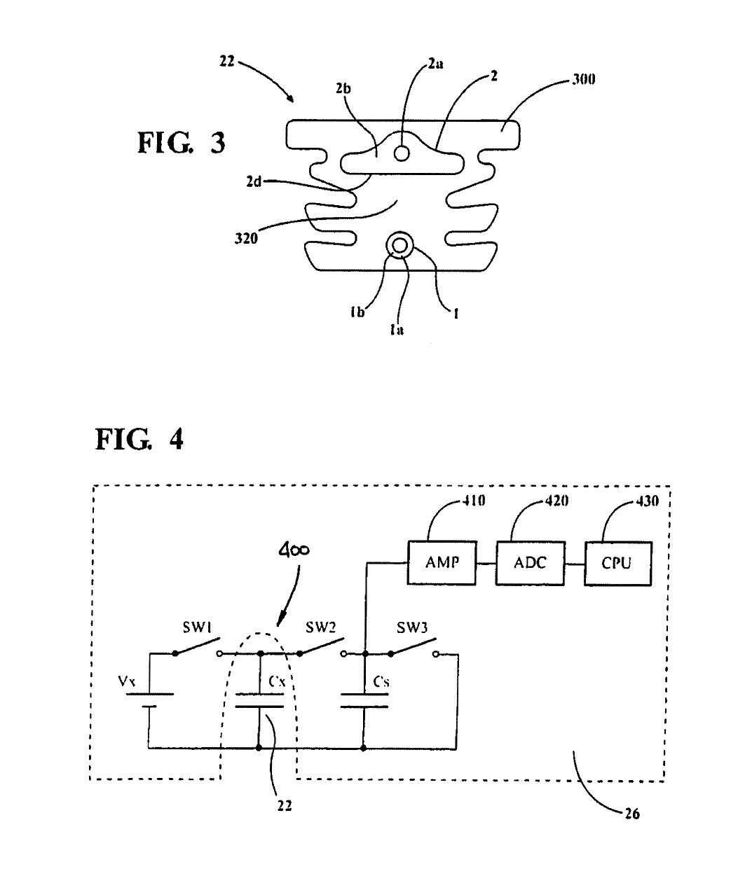

FIG. 3 is a sectional view illustrating a capacitive sensor 22 constructed in accordance with an embodiment of the present disclosure. Capacitive sensor 22 is a two electrode sensor that allows for a capacitive mode of obstacle detection. In general, two electrodes 1, 2 function in a driven shield configuration (i.e., with upper electrode 2 being the driven shield). A case 300 positions the two electrodes 1, 2 in an arrangement that facilitates operation of sensor 22 in a capacitive mode. A first or lower electrode 1 (optionally comprising a conductor 1a embedded in a conductive resin 1b) acts as a capacitive sensor electrode, and a second or upper electrode 2 (optionally comprising a conductor 2a embedded in a conductive resin 2b) acts as a capacitive shield electrode. A dielectric 320 (e.g., a portion 320 of case 300) is disposed between capacitive shield electrode 2 and capacitive sensor electrode 1 to isolate and maintain the distance between the two. Controller (or sensor processor (“ECU”)) 26 is in electrical communication with electrodes 1, 2 for processing sense data received therefrom. Accordingly to one embodiment, capacitive sensor 22 may be similar to that described in U.S. Pat. No. 6,946,853 to Gifford et al., issued Sep. 20, 2005, and incorporated herein by reference.

According to one embodiment, capacitive sensor 22 includes an elongate non-conductive case 300 having two elongate conductive electrodes 1, 2 extending along its length. The electrodes 1, 2 are encapsulated in case 300 and are spaced apart. When an obstacle comes between tailgate 12 and body 16 of vehicle 14, it effects the electric field generated by capacitive sensor electrode 1 which results in a change in capacitance between the two electrodes 1, 2 which is indicative of the proximity of the obstacle to liftgate 12. Hence, the two electrodes 1, 2 function as a capacitive non-contact or proximity sensor.

According to one embodiment, capacitive sensor electrode 1 may include a first conductor 1a embedded in a first partially conductive body 1b and capacitive shield electrode 2 may include a second conductor 2a embedded in a second partially conductive body 2b. The conductors 1a, 2a may be formed from a metal wire. The partially conductive bodies 1b, 2b may be formed from a conductive resin. And, case 300 may be formed from a non-conductive (e.g., dielectric) material (e.g., rubber, etc.). Again, capacitive sensor electrode 1 is separated from capacitive shield electrode 2 by a portion 320 of case 300.

With respect to capacitive sensing, portion 320 of case 300 electrically insulates capacitive sensor electrode 1 and capacitive shield electrode 2 so that electrical charge can be stored therebetween in the manner of a conventional capacitor. According to one embodiment, an inner surface 2d of capacitive shield electrode 2 may be shaped to improve the shielding function of electrode 2. According to one embodiment, inner surface 2d may be flat as shown in FIG. 3.

FIG. 4 is a block diagram illustrating a sensing circuit 400 for a capacitive sensing system 10 that is constructed and operable in accordance with the present disclosure. Sensing circuit 400 may form part of controller 26.

Sensor 22 is used by controller 26 to measure a capacitance (or capacitance value) Cx of an electric field extending through opening 100 under liftgate 12. According to one embodiment, capacitive shield electrode 2 functions as a shielding electrode since it is positioned closer to the sheet metal of liftgate 12. As such, the electric field sensed by capacitive sensor electrode 1 will be more readily influenced by the closer capacitive shield electrode 2 than the vehicle sheet metal.

In general, the capacitance (or capacitance value) Cx of sensor 22 is measured as follows. Capacitive sensor electrode 1 and capacitive shield electrode 2 are charged by controller 26 to the same potential using a pre-determined pulse train sensor signal Vx. For each cycle, controller 26 transfers the charge accumulated between the electrodes 1, 2 to a larger reference capacitor Cs, and records an electrical characteristic indicative of the capacitance Cx of sensor 22. The electrical characteristic may be the resultant voltage Vs across the reference capacitor Cs where a fixed number of cycles is used to charge the electrodes 1, 2, or a cycle count (or time) where a variable number of pulses are used to charge the reference capacitor Cs to a predetermined voltage. The average capacitance of sensor 22 over the cycles may also be directly computed. When an obstacle enters opening 100 under liftgate 12, the dielectric constant between the electrodes 1, 2 will change, typically increasing the capacitance Cx of sensor 22 and thus affecting the recorded electrical characteristic. This increase in measured capacitance Cx is indicative of the presence of the obstacle (i.e., its proximity to liftgate 12).

In more detail, controller 26 uses a charge transfer technique to measure the capacitive value Cx of sensor 22. The charge transfer technique charges sensor 22 (or sensing capacitor Cx) in one phase (switch SW1 closed, switch SW2 open) and discharges the sensing capacitor Cx into a reference (or summing) capacitor Cs in a second phase (SW1 open, SW2 closed). The first two switches SW1 and SW2 are operated in a manner to repeatedly transfer the charge from the sensing capacitor Cx to the reference capacitor Cs.

Sensing circuit 400 is operated to measure the capacitance Cx of sensor 22 in the following manner. In an initial stage, the reference capacitor Cs is reset by discharging the charge on it by temporarily closing the third switch SW3. Then, switches SW1 and SW2 commence operating in two phases that charge the sensing capacitor Cx and transfer the charge from the sensing capacitor Cx to the reference capacitor Cs. The voltage Vs across the reference capacitor Cs rises with each charge transfer phase. The capacitance of the sensing capacitor Cx may be determined by measuring the number of cycles (or time) required to raise the reference capacitor Cs to a predetermined voltage level. Alternatively, the capacitance of the sensing capacitor Cx may be determined by measuring the voltage Vs across the reference capacitor Cs after executing a predetermined number of charge transfer cycles.

With respect to measuring the voltage Vs across the reference capacitor Cs, sensing circuit 400 includes an amplifier 410 for amplifying the voltage Vs. The output of amplifier 410 is coupled to an analog-to-digital converter (“ADC”) 420 which produces a digital signal which is received a processor (“CPU”) 430 of controller 26 for further processing. The measured voltage Vs across the reference capacitor Cs is used by controller 26 to make a determination as to whether an obstacle is present. Controller 26 also outputs the pulse train or sensor signal Vx to sensor 22 (or sensing capacitor Cx) as will be described below.

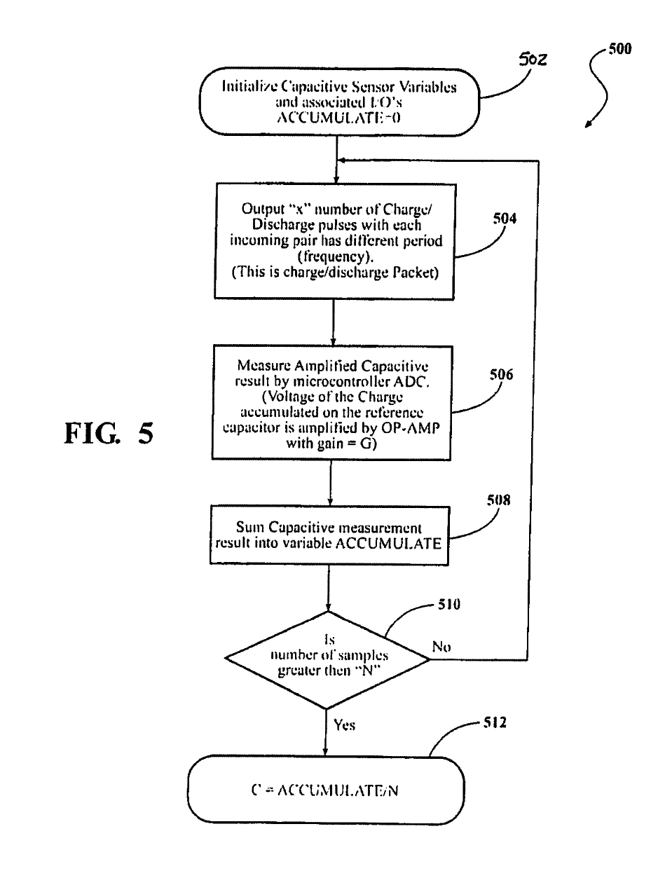

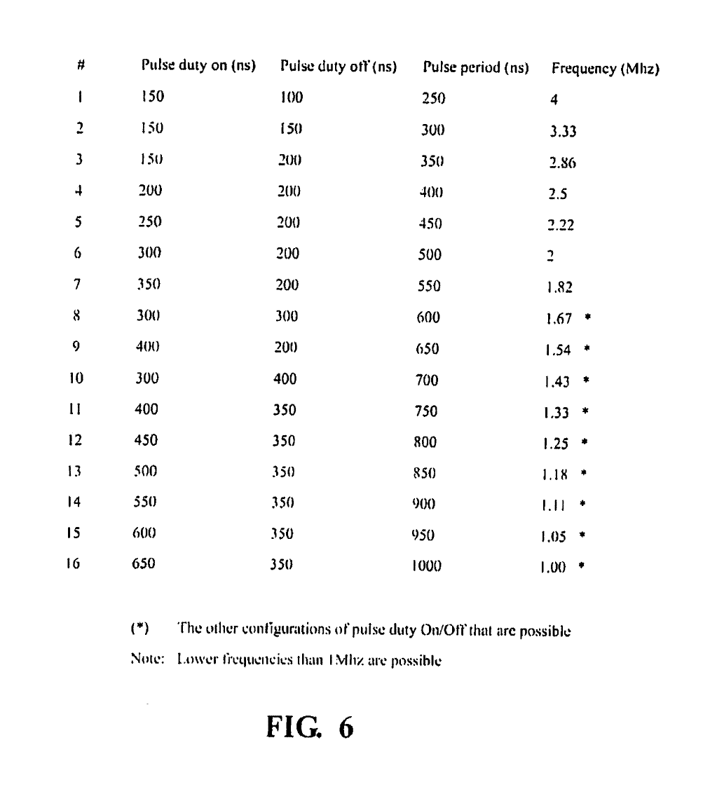

FIG. 5 is a flow chart illustrating a method, cumulatively identified by reference numeral 500, of operating modules within capacitive sensing system 10 for determining a capacitive value Cx of capacitive sensor 22, in accordance with an embodiment of the invention. Additionally, FIG. 6 is a table listing example duty cycles for a sensor signal Vx in accordance with an embodiment of the present invention. Note that as frequency is inversely proportional to period, the pulse periods in the nanosecond (ns) range listed in the table of FIG. 6 correspond to frequencies in the megahertz (MHz) range. For example, a pulse period of 250 ns corresponds to a frequency of 1/(250 ns) or 4 MHz.

As mentioned above, noise emitted by sensor 22 upon application of the sensor signal Vx may be disruptive to external AM, FM, and satellite transmissions. To reduce interference with external AM, FM, satellite, and other transmissions, the present invention uses a spread spectrum sensor signal Vx. By using spread spectrum or frequency hopping signalling, the sensor signal Vx is distributed across many frequencies in a random pattern to thus reduce overall noise levels at any one frequency, as well as being more immune to any one received frequency with respect to noise/interference. By using a driven shield capacitive sensor 22, in combination with higher sensor signal Vx signaling frequencies, longer range proximity capacitive sensing may be achieved.

According to one embodiment, as set forth in FIG. 5, method 500 of operating modules within a capacitive sensing system 10 begins with the module, step or operation, identified by block 502, of initializing the sensor variables and associated I/O's for capacitive sensor 22. For example, the capacitive capacitor Cs could be reset so that the accumulated capacitance value (“ACCUMULATE”) has a value of zero. The method then proceeds to module, step or operation, identified by block 504, for outputting “X” number of charge/discharge pulses, with each incoming pair having a different period. For example, a measurement sample of the reference capacitance voltage Vs is taken every “T” seconds (e.g., T=10 ms). Each measurement sample consists of a number “N” (e.g., N=10) of sample packets that are accumulated. Each of the N sample packets is associated with a number “X” of charge-discharge pulses or pulse pairs output to sensor 22 where each pulse pair has a different period (or frequency). FIG. 6 lists exemplary periods for charge-discharge pulse pairs. The peak electromagnetic interference (“EMI”) emission from sensor 22 is substantially reduced by varying the period (or frequency) of each charge-discharge pulse pair. This may be considered as a form of pulse width modulation (“PWM”) dithering.

The number X of pulse pairs associated with each sample packet may be small (e.g., 5-12). This small number of pulse pairs results in lower EMI emissions from sensor 22 but has a negative effect on measurement sample sensitivity. To achieve higher measurement sample sensitivity, the number N of sample packets is distributed over the measurement sample time T (e.g., 10 ms). For example, 1 sample packet may be output every 1 ms. Thus, a form of oversampling is implemented.

As further shown in FIG. 5, method 500 of operating modules within capacitive sensing system 10 proceeds to module, step or operation, identified by block 506, for measuring an amplified capacitive value that results from the microcontroller ADC. For example, the amplifier (e.g., an operational amplifier or “OP-AMP”) 410 amplifies the accumulated analog charge voltage Vs. The use of oversampling and amplification results in a return of “lost sensitivity” due to the low number X of charge-discharge pulse pairs used. The total sensitivity gain is increased by the amplifier gain G (analog gain) and oversampling (digital gain). Put another way, the voltage of the charge accumulated on the reference capacitor Cs is amplified by OP-AMP with gain=G.

Furthermore, using frequencies for the sensor signal Vx in the MHz range reduces interference due to harmonics with external (e.g., AM) radio transmissions. This reduction in interference is not achievable with lower driving frequencies in the kHz range. Lower frequency sensor signals or their harmonics tend to cause interference with AM, FM, or satellite transmissions. While any radiated signal may cause EMC/EMI issues, higher frequency signalling tends to cause interference with upper AM and FM radio bands. The spread spectrum sensor signalling of the present invention increases the bandwidth in the power spectrum, thus reducing noise at any one frequency (i.e., the interference occurs much less frequently at any one frequency). As such, digital signal processing (“DSP”) within a radio then has the opportunity to remove noise that is not centered at any one fixed frequency. Previous capacitive sensors operating in, for example, the 100 kHz range, have much less bandwidth in which to employ any spread spectrum signalling, if at all, as only less than 100 kHz of bandwidth is available. In contrast, the sensor signalling of the present invention, because it is operating in the MHz range, has ample bandwidth (e.g., several MHZ of bandwidth) in which sensor signalling may be resolved.

As further shown in FIG. 5, method 500 of operating modules within a capacitive sensing system 10 proceeds to a module, step or operation, identified by block 508, for summing or accumulating the samples of resultant voltage Vs measured across the reference capacitor Cs to produce an accumulated capacitance value (“ACCUMULATE”). Method 500 then proceeds to a module, step or operation, identified by block 510, for determining if the number of samples is greater than “N”. If the number of samples is less than “N”, the method 500 proceeds to re-cycle through steps 504, 506, and 508. Once the number of samples is greater than “N”, method 500 proceeds to a module, step or operation, identified by block 512, where the accumulated capacitance value (“ACCUMULATE”) is divided by the number N of the samples to determine the capacitance value Cx. Put another way, as shown in FIG. 5, the final measurement sample of the capacitance value Cx is arrived at by dividing the ACCUMULATED by N accordingly. As a result, a 10 fold larger measurement sample (“ACCUMULATE”) as a result of accumulation can be achieved.

Thus, according to one embodiment, there is provided a method for determining a capacitance value Cx of a capacitive sensor 22, comprising: applying a sensor signal Vx to the capacitive sensor 22, the sensor signal Vx comprising a number X of charge-discharge pulse pairs distributed over a first period of time T/N, each pulse pair having a different pulse period; accumulating a number N of samples of a reference voltage Vs measured across a reference capacitor Cs coupled to the capacitive sensor 22 over a second period of time T to produce an accumulated capacitance value (ACCUMULATE); and, dividing the accumulated capacitance value (ACCUMULATE) by the number N of the samples to determine the capacitance value Cx.

In the above method, the pulse period may, in one non-limiting example embodiment, be between approximately 250 ns and approximately 1000 ns. The number X of charge-discharge pulse pairs may, in one non-limiting example embodiment, be between 5 and 12. The second period of time T may be 10 ms, the number of samples N may be 10, and the first period of time T/N may be 1 ms. The capacitive sensor 22 may be a driven shield capacitive sensor. And, the capacitive sensor 22 may be a capacitive sensor 22 in a capacitive sensing system 10 for a liftgate 12 of a vehicle 14.

The above embodiments contribute to an improved method and system for driving capacitive sensors 22 and provide one or more advantages. First, using frequencies for the sensor signal Vx in the MHz range reduces interference due to harmonics with external (e.g., AM) radio transmissions. Second, using spread spectrum sensor signals Vx reduces the maximum power of EMI signals output by the capacitive sensor 22.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method for determining a capacitance value of a capacitive sensor, comprising:
applying a sensor signal to the capacitive sensor, the sensor signal comprising a number of charge-discharge pulse pairs distributed over a first period of time, each pulse pair having a different pulse period;
accumulating a number of samples of a resultant voltage measured across a reference capacitor coupled to the capacitive sensor over a second period of time to produce an accumulated capacitance value; and
dividing the accumulated capacitance value by the number of the samples to determine the capacitance value.

2. The method as claimed in claim 1, wherein the pulse period is between approximately 250 ns and approximately 1000 ns.

3. The method as claimed in claim 1, wherein the number of charge-discharge pulse pairs is between 5 and 12.

4. The method as claimed in claim 1, wherein the second period of time is 10 ms, the number of samples is 10, and the first period of time is 1 ms.

5. The method as claimed in claim 1, wherein the sensor signal is a spread spectrum sensor signal.

6. The method as claimed in claim 1, further comprising:
amplifying each of the resultant voltages with an amplifier prior to producing the accumulated capacitance value.

7. The method as claimed in claim 6, further comprising:
producing a digital signal using an analog-to-digital converter coupled to the amplifier; and
recording the digital signal using a controller coupled to the analog-to-digital converter.

8. The method as claimed in claim 1, wherein the capacitive sensor includes a capacitive sensor electrode and a capacitive shield electrode, and said step of applying the sensor signal to the capacitive sensor includes charging the capacitive sensor electrode and the capacitive shield electrode to the same potential using the sensor signal.

9. The method as claimed in claim 8, wherein each measurement of the reference voltage further comprises:
transferring the charge accumulated between the capacitive sensor electrode and the capacitive shield electrode to a reference capacitor; and
measuring the resultant voltage across the reference capacitor.

10. The method as claimed in claim 9, further comprising:
closing a first switch disposed between the sensor signal and the capacitive sensor and opening a second switch disposed between the capacitive sensor and the reference capacitor to effectuate the transfer of the charge to the electrodes.

11. The method as claimed in claim 10, further comprising:
opening the first switch and closing the second switch to effectuate the transfer of charge from the electrodes to the reference capacitor.

12. The method as claimed in claim 1, further comprising:
re-setting the reference capacitor prior to said step of applying a sensor signal to the capacitive sensor.

13. The method as claimed in claim 12, wherein said step of re-setting the reference capacitor includes closing a third switch coupled to the reference capacitor.

14. The method as claimed in claim 1, wherein the capacitive sensor is a driven shield capacitive sensor.

15. The method as claimed in claim 14, wherein the capacitive sensor is a capacitive sensor in a capacitive sensing system for a liftgate of a vehicle.

16. A power closure system for a motor vehicle, comprising:
a closure member moveable relative to a body portion of the motor vehicle between open and closed positions;
a power-operated drive mechanism operable for moving the closure member between its open and closed positions;
a capacitive sensor mounted to one of the closure member and the body portion; and
a controller for controlling operation of the power-operated drive mechanism, the controller being further operable for determining a capacitive value of the capacitive sensor by applying a sensor signal to the capacitive sensor comprising a number of charge-discharge pulse pairs distributed over a first period of time with each pulse pair having a different pulse period, accumulating a number of samples of a resultant voltage measured across a reference capacitor coupled to the capacitor sensor over a second period of time to produce an accumulated capacitance value, and dividing the accumulated capacitance value by the number of samples to determine the capacitance value.
